(19) United States
(12) Patent Application Publication
(10) Pub. No.: US 2026/0016945 A1
(43) Pub. Date: Jan. 15, 2026

(54) INPUT SYSTEM, ELECTRONIC DEVICE, AND COMPUTER PROGRAM

(71) Applicant: Wacom Co., Ltd., Saitama (JP)

(72) Inventor: Jason GERECKE, Portland, OR (US)

(73) Assignee: Wacom Co., Ltd., Saitama (JP)

(21) Appl. No.: 19/332,742

(22) Filed: Sep. 18, 2025

Related U.S. Application Data
(63) Continuation of application No. PCT/JP2023/028234, filed on Aug. 2, 2023.
(60) Provisional application No. 63/504,679, filed on May 26, 2023.

(51) Int. Cl. G06F 3/04847; G06F 3/0354; G06F 3/041; G06F 3/044

(52) U.S. Cl. CPC G06F 3/04847; G06F 3/03545; G06F 3/0414; G06F 3/0441

(57) ABSTRACT

An input system includes a position detection device and an electronic device. The position detection device and the electronic device are connectable to each other for communication. The position detection device detects a position indicated by an indicator in a position detection area set on the position detection device. The electronic device executes a process according to a position of a display area corresponding to the indicated position detected in the position detection area and being set on a display screen of the electronic device. The electronic device includes a setting information generator and a transmission control. The setting information generator generates second setting information for configuring settings in relation to an aspect ratio of the position detection area, according to first setting information set in relation to an aspect ratio of the display area when the position detection device and the electronic device are connected for communication.

### BACKGROUND

### Technical Field

The present disclosure relates to an input system, an electronic device, and a computer program.

### Description of the Related Art

Conventionally, a pen tablet is known as an input device used for an electronic device, such as a desktop personal computer (PC), a laptop PC, and a smartphone (for example, see Japanese Patent Laid-Open No. 2002-244806).

As illustrated in FIG. 1, a pen tablet 1 includes, for example, a pen-type position indicator 2 (electronic pen) and a substantially planar position detection device 3. A user holds the position indicator 2 in hand and indicates a desired position of a position detection area 3A set on the position detection device 3. Consequently, the position detection device 3 detects the position (coordinates) indicated by the user as an indicated position and outputs the detected indicated position to an externally connected electronic device 5.

The user can perform an input operation on the electronic device 5 by operating the position indicator 2 as if the user were drawing a character or a picture with a pen. The feeling of operation is very natural, and it is well received. For example, when the user uses an application program to make a drawing on the electronic device 5, the user can use the pen tablet 1 to perform an operation (drawing operation), just like drawing a picture, of inputting a drawing position in a display area 6A set on a display screen 6 of the electronic device 5. It is evident that these drawing capabilities are very convenient for users.

In some cases, the aspect ratio of the position detection area 3A set on the position detection device 3 is significantly different from the aspect ratio of the display area 6A set on the display screen 6. In this case, as illustrated in FIG. 1, when the user holds the position indicator 2 in hand and indicates a desired position of the position detection area 3A so as to draw a circle, the circle vertically stretches according to the difference between the aspect ratio of the position detection area 3A and the aspect ratio of the display area 6A, and an ellipse is drawn in the display area 6A, for example.

Therefore, a setting screen for setting the range of the position detection area 3A on the position detection device 3 and a range of the display area 6A on the display screen 6 is conventionally prepared to prevent the difference between the aspect ratio of the position detection area 3A and the aspect ratio of the display area 6A from becoming large. The user can, for example, display the setting screen on the electronic device 5 and freely set the range of the position detection area 3A on the position detection device 3 and the range of the display area 6A on the display screen 6.

However, a notable problem is that it takes a lot of work for the user to reduce the difference between the aspect ratio of the position detection area 3A and the aspect ratio of the display area 6A. The user must check the difference between the aspect ratios, display the setting screen, manually set the range of the position detection area 3A on the position detection device 3, and manually set the range of the display area 6A on the display screen 6.

### BRIEF SUMMARY

An object of the present disclosure is to provide an input system, an electronic device, and a computer program that can reduce the difference between the aspect ratio of a position detection area and the aspect ratio of a display area without the time and effort of the user.

The present disclosure provides an input system configured as follows.

[1] An input system including a position detection device, and an electronic device, in which the position detection device and the electronic device are connectable to each other for communication, the position detection device detects a position indicated by an indicator in a position detection area set on the position detection device, the electronic device executes a process according to a position of a display area that corresponds to the indicated position detected in the position detection area and that is set on a display screen of the electronic device, the electronic device includes a setting information generator and a transmission control, the setting information generator generates second setting information for configuring settings in relation to an aspect ratio of the position detection area, according to first setting information set in relation to an aspect ratio of the display area when the position detection device and the electronic device are connected for communication, the transmission control transmits the generated second setting information to the position detection device, the position detection device includes a setting control, and the setting control configures the settings related to the aspect ratio of the position detection area according to the second setting information transmitted from the transmission control.

According to the present disclosure, the second setting information for configuring the settings in relation to the aspect ratio of the position detection area is transmitted to and set in the position detection device, according to the first setting information set in relation to the aspect ratio of the display area, when the position detection device and the electronic device are connected for communication. This can reduce the difference between the aspect ratio of the position detection area and the aspect ratio of the display area without the time and effort of the user.

Various embodiments of the present disclosure will be illustrated. The embodiments illustrated below can be combined with each other.

[2] The input system according to [1], in which the setting control changes a set position of the position detection area on the position detection device according to a user operation on an operation unit after configuring the settings related to the aspect ratio of the position detection area according to the second setting information.

[3] The input system according to [1] or [2], in which the position detection device further includes a notification unit, and the notification unit sends a notification when the position detection device and the electronic device are connected for communication.

[4] The input system according to [3], in which the notification unit sends a notification of a set position of the position detection area in a notification mode according to the set position of the position detection area.

[5] The input system according to any one of [1] to [4], in which, when a display mode of the display screen is changed from one of a vertical display mode and a horizontal display mode to the other, the setting information generator generates the second setting information according to the display mode after the change.

[6] The input system according to any one of [1] to [5], in which, when an arrangement direction of the position detection device is changed from one of a vertical direction and a horizontal direction to the other, the setting information generator generates the second setting information for setting the position detection area in a size larger than the display area.

[7] An electronic device including a process execution unit, a setting information generator, and a transmission control, in which the electronic device is connectable for communication to the position detection device, the position detection device detects a position indicated by an indicator in a position detection area set on the position detection device, the process execution unit executes a process according to a position of a display area that corresponds to the indicated position detected in the position detection area and that is set on a display screen of the electronic device, the setting information generator generates second setting information for configuring settings in relation to an aspect ratio of the position detection area, according to first setting information set in relation to an aspect ratio of the display area, when the position detection device and the electronic device are connected for communication, and the transmission control transmits the generated second setting information to the position detection device.

[8] A computer program causing an electronic device to function, in which the electronic device is connectable for communication to a position detection device, the position detection device detects a position indicated by an indicator in a position detection area set on the position detection device, the electronic device includes a process execution unit, a setting information generator, and a transmission control, the computer program causes the process execution unit to execute a process according to a position of a display area that corresponds to the indicated position detected in the position detection area and that is set on a display screen of the electronic device, the computer program causes the setting information generator to generate second setting information for configuring settings in relation to an aspect ratio of the position detection area, according to first setting information set in relation to an aspect ratio of the display area, and the computer program causes the transmission control to transmit the generated second setting information to the position detection device.

According to the present disclosure, the difference between the aspect ratio of the position detection area and the aspect ratio of the display area can be reduced without the time and effort of the user.

### BRIEF DESCRIPTION OF THE SEVERAL VIEWS OF THE DRAWINGS

FIG. 1 is a diagram describing a conventional problem;

FIG. 2 depicts a configuration example of an input system in the present embodiment;

FIG. 3 is a block diagram illustrating a hardware configuration of a position detection device in the present embodiment;

FIG. 4 depicts a configuration example of a position detector and a sensor in the present embodiment;

FIG. 5 is a block diagram illustrating a hardware configuration of an electronic device in the present embodiment;

FIG. 6 is a block diagram illustrating an example of functional components of the electronic device in the present embodiment;

FIG. 7 is a block diagram illustrating an example of functional components of the position detection device in the present embodiment;

FIG. 8 is a flow chart illustrating an example of a setting information generation process executed by the electronic device;

FIG. 9 is a flow chart illustrating an example of a setting process executed by the position detection device;

FIG. 10 depicts an example of drawing action after a position detection area is set according to second setting information;

FIG. 11 is an explanatory diagram describing an action of changing a set position of the position detection area;

FIG. 12 is an explanatory diagram describing an action of sending a notification of the set position of the position detection area;

FIG. 13 is an explanatory diagram describing an action when a display mode of a display screen is changed; and

FIG. 14 is an explanatory diagram describing an action when an arrangement direction of the position detection device is changed.

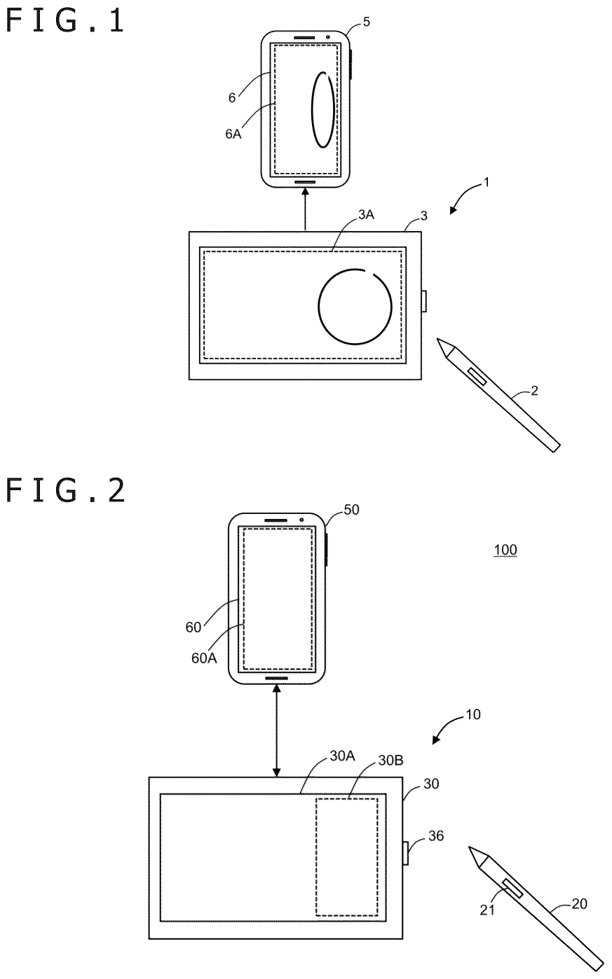

### DETAILED DESCRIPTION

An embodiment of the present disclosure will be described with reference to the attached drawings. Note that, in the drawings, components provided with the same reference signs have the same or similar configurations.

### Configuration of Input System 100

FIG. 2 illustrates a configuration of an input system 100 in the present embodiment. The input system 100 includes a pen tablet 10 and an electronic device 50. The pen tablet 10 includes a pen-type position indicator 20 (electronic pen) and a substantially planar position detection device 30 (tablet).

The position detection device 30 is a pad terminal configured to use an electromagnetic resonance sensor 38 to detect the position indicated by an electromagnetic resonance indicator including the position indicator 20. Note that the position detection device 30 may use a capacitance sensor to detect the position indicated by an indicator, such as a finger of a user or the position indicator 20.

The electronic device 50 is an information processing terminal, such as a smartphone or a tablet terminal. Note that the electronic device 50 may be any terminal, such as a mobile phone, a PC, a laptop PC, a personal digital assistant (PDA), or a video game console.

The user holds the position indicator 20 (corresponding to an “indicator” of the present disclosure) in hand to indicate a desired position (coordinates) of a position detection area 30B set on a configurable area 30A of the position detection device 30. As a result, the position detection device 30 detects the position indicated by the user as an indicated position and outputs indicated position information representing the detected indicated position to the externally connected electronic device 50.

Note that an operation button 21 for a side switch is provided on a side surface of the position indicator 20. The operation button 21 is a button for initiating, for example, functions corresponding to what is generally called left click button and right click button of a mouse as a pointing device. When the operation button 21 is operated by the user, the position indicator 20 transmits operation information indicative of the operation to the position detection device 30.

The position detection device 30 and the electronic device 50 can be connected for communication. For example, the position detection device 30 and the electronic device 50 can be connected for communication through near field communication such as Bluetooth (registered trademark). The position detection device 30 and the electronic device 50 can also be connected for communication through a communication cable such as a universal serial bus (USB) cable.

The user can perform an input operation for the electronic device 50 by operating the position indicator 20 as if the user were drawing a character or a picture with a pen. For example, the user can use an application program to make a drawing on the electronic device 50 and perform an operation (drawing operation) of inputting a drawing position in a display area 60A set on a display screen 60 of the electronic device 50. In this case, the user can use the pen tablet 10 to perform the operation just like drawing a picture.

Specifically, the electronic device 50 receives the indicated position information output from the position detection device 30 to generate display information of a writing trace as a temporal continuous change of the position on the position detection area 30B indicated by the position indicator 20 (trajectory of the indicated position on the position detection area 30B of the position indicator 20) and displays the display information in the display area 60A on the display screen 60.

Other than the indicated position information, the electronic device 50 in the present embodiment receives, from the position detection device 30, position detection related information supplied from the position indicator 20 to the position detection device 30 when the position is indicated and input on the position detection area 30B by the position indicator 20. The position detection related information includes pen pressure information, identification information, and the like transmitted from the position indicator 20 to the position detection device 30. Pen attributes, such as the type of pen, the hardness of core body, the thinness of core body, and the shape of core body, are set in advance in the identification information. The electronic device 50 uses the position detection related information received from the position detection device 30 when the electronic device 50 displays, in the display area 60A on the display screen 60, the writing trace and the like based on the indicated position information received from the position detection device 30.

### Hardware Configuration of Position Detection Device 30

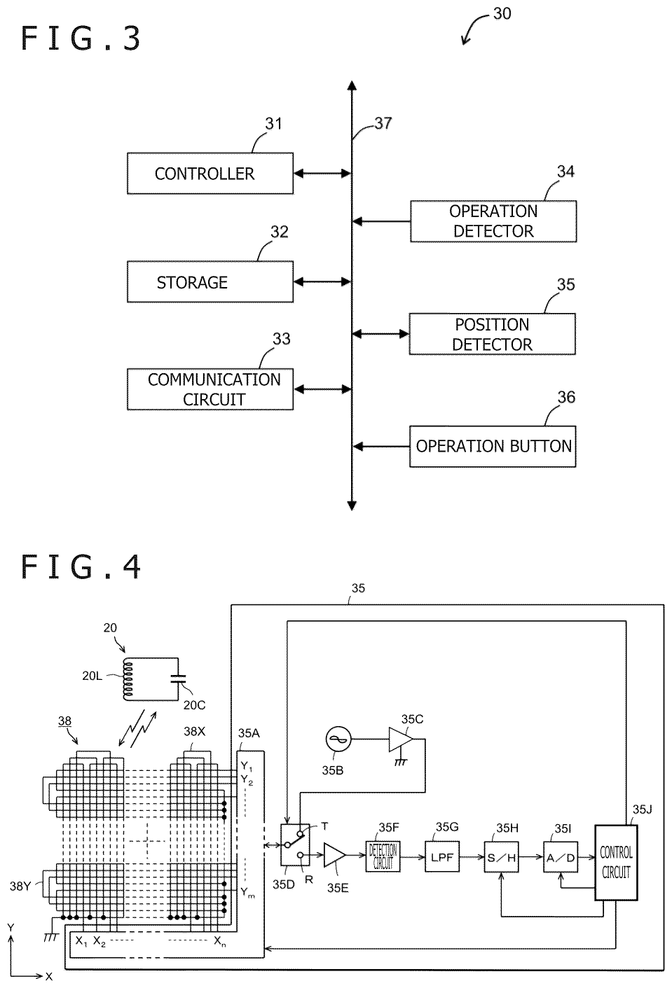

FIG. 3 is a block diagram illustrating a hardware configuration of the position detection device 30 in the present embodiment. As illustrated in FIG. 3, the position detection device 30 includes a controller 31, a storage 32, a communication circuit 33, an operation detector 34, a position detector 35, and an operation button 36.

The controller 31 is, for example, a central processing unit (CPU), a microprocessor, a digital signal processor (DSP), or the like, and the controller 31 controls the entire action of the position detection device 30.

Part of the storage 32 includes, for example, a random access memory (RAM), a dynamic random access memory (DRAM), or the like, and the part of the storage 32 is used as a work area or the like in processing based on various programs executed by the controller 31.

Also, part of the storage 32 is, for example, a non-volatile memory such as a read only memory (ROM), or a hard disk drive (HDD), and the part of the storage 32 saves various pieces of data and programs and the like used for processing by the controller 31. The storage 32 can hold a database including one or more tables and the like for recording various types of information, processing results, and the like.

The programs stored in the storage 32 include, for example, an operating system (OS) that realizes basic functions of the position detection device 30, a driver that controls various types of hardware, programs that realize various functions, and the like. The programs may be stored in a computer-readable non-transitory recording medium.

The communication circuit 33 has a function of connecting to the electronic device 50. For example, the communication circuit 33 has a function of allowing near field communication such as Bluetooth (registered trademark), and communication through a communication cable such as a USB cable. The position detection device 30 is connected to the electronic device 50 through the communication circuit 33, and the position detection device 30 can transmit and receive various pieces of data to and from the electronic device 50.

The operation detector 34 receives the operation information transmitted from the position indicator 20 to detect that the operation button 21 provided on the side surface of the position indicator 20 is operated by the user.

The position detector 35 detects the position indicated by the position indicator 20 in the position detection area 30B set on the configurable area 30A and outputs the indicated position information representing the detected indicated position to the controller 31.

The operation button 36 is provided on a side surface of the position detection device 30. The operation button 36 is configured as a power button for starting or stopping the position detection device 30 and as a button for setting the position detection area 30B on the configurable area 30A of the position detection device 30.

The controller 31, the storage 32, the communication circuit 33, the operation detector 34, the position detector 35, and the operation button 36 are electrically connected to each other through a system bus 37. Therefore, the controller 31 can access the storage 32, figure out the state of the operation button 21 of the position indicator 20 operated by the user, figure out the state of the detection state of the position indicated by the position indicator 20, and access the electronic device 50 through the communication circuit 33.

### Configuration Example of Position Detector 35 and Sensor 38

A configuration example of the position detector 35 and the sensor 38 will be described with reference to FIG. 4. In the present embodiment, the position indicator 20 used along with the sensor 38 includes a resonant circuit including a coil 20L and a capacitor 20C connected in parallel to the coil 20L.

The sensor 38 is provided with an X-axis direction loop coil group 38X and a Y-axis direction loop coil group 38Y. Each of the X-axis direction loop coil group 38X and the Y-axis direction loop coil group 38Y includes a plurality of rectangular loop coils. In the present embodiment, n loop coils are arranged in an X-axis direction, and m loop coils are arranged in a Y-axis direction. The loop coils of the X-axis direction loop coil group 38X and the Y-axis direction loop coil group 38Y are arranged to overlap with each other.

The loop coils included in the X-axis direction loop coil group 38X are lined up at equal intervals and sequentially arranged to overlap with each other in a horizontal direction (X-axis direction) of the configurable area 30A for detecting the position indicated by the position indicator 20. The loop coils included in the Y-axis direction loop coil group 38Y are lined up at equal intervals and sequentially arranged to overlap with each other in a vertical direction (Y-axis direction) of the configurable area 30A.

The position detector 35 is connected to the sensor 38. The position detector 35 includes a selection circuit 35A, an oscillator 35B, a current driver 35C included in a transmission amplifier, a transmission-reception switch circuit 35D, a reception amplifier 35E, a detection circuit 35F, a low-pass filter 35G, a sample and hold circuit 35H, an analog to digital (A/D) conversion circuit 35I, and a control circuit 35J.

The X-axis direction loop coil group 38X and the Y-axis direction loop coil group 38Y are connected to the selection circuit 35A. The selection circuit 35A sequentially selects each loop coil of the two loop coil groups 38X and 38Y according to the control of the control circuit 35J.

The oscillator 35B generates an AC signal with a frequency f0. The AC signal is supplied to the current driver 35C, converted into a current, and sent out to the transmission-reception switch circuit 35D. The control circuit 35J controls the transmission-reception switch circuit 35D to switch, at predetermined intervals, connection points (a transmission-side terminal T and a reception-side terminal R) of the loop coils selected by the selection circuit 35A. The current driver 35C is connected to the transmission-side terminal T, and the reception amplifier 35E is connected to the reception-side terminal R.

Therefore, during the transmission, the AC signal converted into the current by the current driver 35C is supplied to the loop coil selected by the selection circuit 35A through the transmission-side terminal T of the transmission-reception switch circuit 35D. During the reception, an induced voltage generated by the loop coil selected by the selection circuit 35A is supplied to and amplified by the reception amplifier 35E through the selection circuit 35A and the reception-side terminal R of the transmission-reception switch circuit 35D and sent out to the detection circuit 35F.

The induced voltage amplified by the reception amplifier 35E is detected by the detection circuit 35F and supplied to the A/D conversion circuit 35I through the low-pass filter 35G and the sample and hold circuit 35H. The A/D conversion circuit 35I converts the signal supplied through the low-pass filter 35G and the sample and hold circuit 35H from an analog signal to a digital signal and supplies the signal to the control circuit 35J.

The control circuit 35J controls the detection of the indicated position. That is, the control circuit 35J controls the selection of the loop coil in the selection circuit 35A, the switch of the signal in the transmission-reception switch circuit 35D, the timing of the sample and hold circuit 35H, and the like.

The control circuit 35J switches the transmission-reception switch circuit 35D to connect it to the transmission-side terminal T to thereby control the conduction of the loop coil selected by the selection circuit 35A in the X-axis direction loop coil group 38X or the Y-axis direction loop coil group 38Y to cause the loop coil to send out a magnetic field. The resonant circuit of the position indicator 20 functions to receive the magnetic field sent out from the loop coil, store the magnetic energy, and transmit the magnetic field based on the stored magnetic energy to the sensor 38.

The control circuit 35J switches the transmission-reception switch circuit 35D to connect it to the reception-side terminal R. Consequently, an induced voltage is generated in each loop coil of the X-axis direction loop coil group 38X and the Y-axis direction loop coil group 38Y due to the magnetic field transmitted from the position indicator 20.

The control circuit 35J calculates coordinate values of the indicated position in the X-axis direction and the Y-axis direction in the detection area of the sensor 38, according to the voltage value of the induced voltage generated in each loop coil. The control circuit 35J detects the position indicated by the position indicator 20 from the calculated coordinate values and outputs the detection result to the controller 31.

### Hardware Configuration of Electronic Device 50

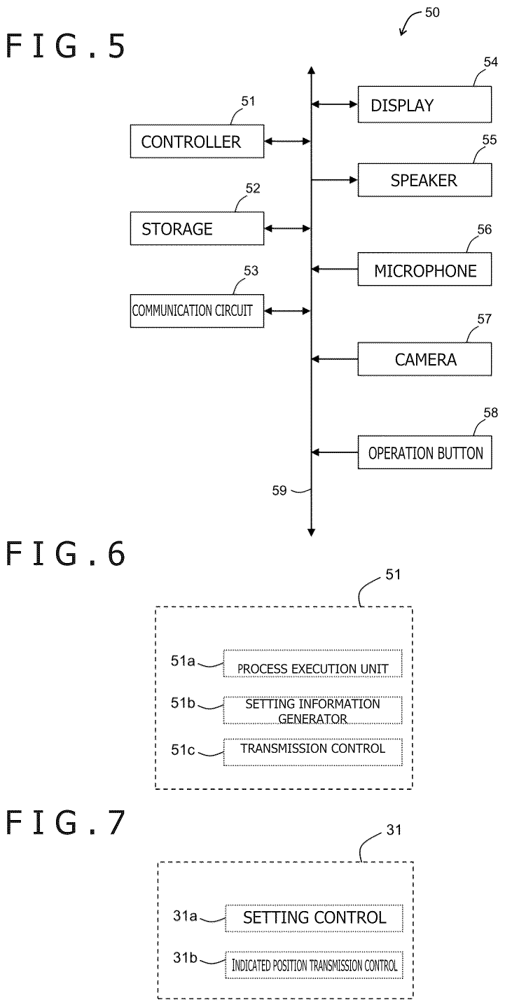

FIG. 5 is a block diagram illustrating a hardware configuration of the electronic device 50 in the present embodiment. As illustrated in FIG. 5, the electronic device 50 includes a controller 51, a storage 52, a communication circuit 53, a display 54, a speaker 55, a microphone 56, a camera 57, and an operation button 58.

The controller 51 is, for example, a CPU, a microprocessor, a DSP, or the like, and the controller 51 controls the entire action of the electronic device 50.

Part of the storage 52 includes, for example, a RAM, a DRAM, or the like. This part of the storage 52 is used as a work area or the like in processing based on various programs executed by the controller 51.

Also, part of the storage 52 is, for example, a non-volatile memory such as a ROM, or an HDD. This part of the storage 52 saves various pieces of data and programs and the like used for processing by the controller 51. The storage 52 can hold a database including one or more tables and the like for recording various types of information, processing results, and the like.

The programs (corresponding to a “computer program” of the present disclosure) stored in the storage 52 include, for example, an OS that realizes basic functions of the electronic device 50, a driver that controls various types of hardware, programs that realize various functions, and the like. The programs may be stored in a computer-readable non-transitory recording medium.

The communication circuit 53 has a function of connecting to the position detection device 30. For example, the communication circuit 53 has a function of allowing near field communication such as Bluetooth (registered trademark), communication through a communication cable such as a USB cable, and the like. The electronic device 50 is connected to the position detection device 30 through the communication circuit 53, and the electronic device 50 can transmit and receive various pieces of data to and from the position detection device 30.

The display 54 is a touch panel display or the like, and the display 54 can display an image and the like and receive an operation by the user.

The controller 51 controls the speaker 55 to output various sounds. The controller 51 controls the microphone 56 to input various sounds. The controller 51 controls the camera 57 to image a subject.

The operation button 58 is provided on, for example, a side surface of the electronic device 50. The operation button 58 is a power button for starting or stopping the electronic device 50, a button for adjusting the volume of sound output from the speaker 55, and the like.

The controller 51, the storage 52, the communication circuit 53, the display 54, the speaker 55, the microphone 56, the camera 57, and the operation button 58 are electrically connected to each other through a system bus 59. Therefore, the controller 51 can access the storage 52, display an image on the display 54, figure out the state of the touch panel display (display 54) or the operation button 58 operated by the user, input sound to the microphone 56, output sound from the speaker 55, control the camera 57, and access the position detection device 30 through the communication circuit 53.

### Functional Components of Controller 51 Included in Electronic Device 50

FIG. 6 is a block diagram illustrating an example of functional components of the controller 51 included in the electronic device 50 in the present embodiment. As illustrated in FIG. 6, the controller 51 includes functional components including a process execution unit 51a, a setting information generator 51b, and a transmission control 51c. Although the controller 51 of the electronic device 50 generally has various other functions than those described above, only characteristic functions in the input system 100 in the present embodiment will be described here, and other known functions and the like will not be illustrated and described.

The process execution unit 51a executes a predetermined process according to the position of the display area 60A corresponding to the indicated position detected in the position detection area 30B, according to mapping information representing the correspondence (mapping) between the position in the position detection area 30B set on the configurable area 30A of the position detection device 30 and the position in the display area 60A set on the display screen 60 of the electronic device 50, when the position detection device 30 and the electronic device 50 are connected for communication.

The predetermined process is, for example, a process of generating display information of a writing trace or a cursor as a temporal continuous change of the position on the position detection area 30B indicated by the position indicator 20, and displaying the display information in the display area 60A on the display screen 60. The mapping information is generated by the controller 51 and stored in the storage 52 when the display area 60A is set on the entire area or partial area of the display screen 60 of the electronic device 50 and the position detection area 30B is set on the entire area or partial area of the configurable area 30A of the position detection device 30 through the operation of the user on the display 54 of the electronic device 50.

The setting information generator 51b generates second setting information for configuring the settings in relation to the aspect ratio of the position detection area 30B, according to first setting information set in relation to the aspect ratio of the display area 60A, when the position detection device 30 and the electronic device 50 are connected for communication.

The first setting information is generated by the controller 51 and stored in the storage 52 when the display area 60A is set on the entire area or partial area of the display screen 60 of the electronic device 50 through the operation of the user on the display 54 of the electronic device 50 before the position detection device 30 and the electronic device 50 are connected for communication. The first setting information is information indicating the aspect ratio of the display area 60A calculated according to the vertical length and the horizontal length (size) of the display area 60A set on the display screen 60. Note that the first setting information may be any information that allows to obtain the aspect ratio of the display area 60A, and the first setting information may be, for example, information indicating the vertical length and the horizontal length of the display area 60A set on the display screen 60.

The setting information generator 51b refers to the first setting information and the mapping information stored in the storage 52 and generates the second setting information for configuring the settings in relation to the aspect ratio of the position detection area 30B to bring the aspect ratio of the display area 60A into line with the aspect ratio of the position detection area 30B. The second setting information is information indicating the aspect ratio of the position detection area 30B calculated according to the vertical length and the horizontal length of the position detection area 30B set on the configurable area 30A of the position detection device 30. Note that the second setting information may be any information that allows the aspect ratio of the position detection area 30B to be obtained, and the second setting information may be, for example, information indicating the vertical length and the horizontal length of the position detection area 30B set on the configurable area 30A.

The transmission control 51c transmits the second setting information to the position detection device 30 through the communication circuit 53 when the second setting information is generated by the setting information generator 51b. The transmission control 51c also transmits the mapping information to the position detection device 30 through the communication circuit 53 when the mapping information is generated by the controller 51.

### Functional Components of Controller 31 Included in Position Detection Device 30

FIG. 7 is a block diagram illustrating an example of functional components of the controller 31 included in the position detection device 30 in the present embodiment. As illustrated in FIG. 7, the controller 31 includes functional components including a setting control 31a and an indicated position transmission control 31b. Note that, although the controller 31 of the position detection device 30 generally has various other functions than those described above, only characteristic functions in the input system 100 in the present embodiment will be described, and other known functions and the like will not be illustrated and described.

The setting control 31a configures the settings related to the aspect ratio of the position detection area 30B set on the configurable area 30A of the position detection device 30, according to the second setting information and the mapping information transmitted from the transmission control 51c of the electronic device 50.

For example, the setting control 31a refers to the mapping information and sets the entire configurable area 30A as the maximum range when the position detection area 30B is set on the entire configurable area 30A of the position detection device 30. The setting control 31a sets the vertical length, the horizontal length, and the position of the position detection area 30B on the configurable area 30A to ensure the aspect ratio of the position detection area 30B indicated by the second setting information. Also, the setting control 31a refers to the mapping information to set the partial area on the configurable area 30A as the maximum range when the position detection area 30B is set on the partial area on the configurable area 30A of the position detection device 30. The setting control 31a sets the vertical length, the horizontal length, and the position of the position detection area 30B on the configurable area 30A to ensure the aspect ratio of the position detection area 30B indicated by the second setting information.

Every time the position detector 35 detects the indicated position in the position detection area 30B set by the setting control 31a, the indicated position transmission control 31b transmits the indicated position information representing the indicated position to the electronic device 50 through the communication circuit 33.

### Setting Information Generation Process Executed by Electronic Device 50

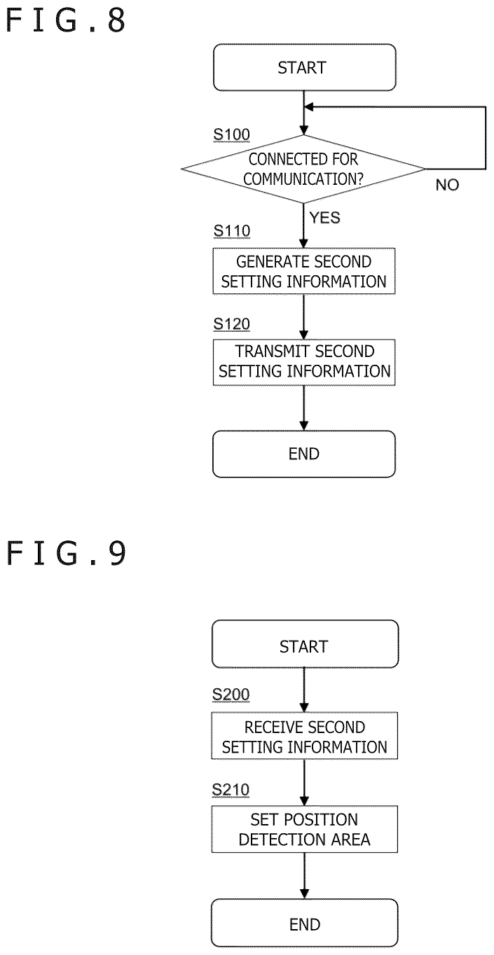

FIG. 8 is a flow chart illustrating an example of a setting information generation process executed by the electronic device 50 in the present embodiment.

The controller 51 first determines whether the position detection device 30 and the electronic device 50 are connected for communication (step S100). As a result of the determination, if the position detection device 30 and the electronic device 50 are not connected for communication (step S100, NO), the process returns to before step S100.

Conversely, if the position detection device 30 and the electronic device 50 are connected for communication (step S100, YES), the setting information generator 51b generates the second setting information for configuring the settings in relation to the aspect ratio of the position detection area 30B, according to the first setting information set in relation to the aspect ratio of the display area 60A (step S110). In the present embodiment, the setting information generator 51b refers to the first setting information and the mapping information stored in the storage 52 and generates the second setting information for configuring the settings in relation to the aspect ratio of the position detection area 30B to bring the aspect ratio of the display area 60A into line with the aspect ratio of the position detection area 30B.

Lastly, the transmission control 51c transmits the second setting information generated by the setting information generator 51b to the position detection device 30 through the communication circuit 53 (step S120). When the process of step S120 is completed, the electronic device 50 ends the process illustrated in FIG. 8.

### Setting Process Executed by Position Detection Device 30

FIG. 9 is a flow chart illustrating an example of a setting process executed by the position detection device 30 in the present embodiment. Note that the mapping information is transmitted in advance from the transmission control 51c of the electronic device 50 to the position detection device 30 before step S200.

The controller 31 first receives the second setting information transmitted from the transmission control 51c of the electronic device 50 (step S200).

The setting control 31a then configures the settings related to the aspect ratio of the position detection area 30B set on the configurable area 30A of the position detection device 30, according to the second setting information and the mapping information transmitted from the transmission control 51c of the electronic device 50 (step S210). When the process of step S210 is completed, the position detection device 30 ends the process illustrated in FIG. 9.

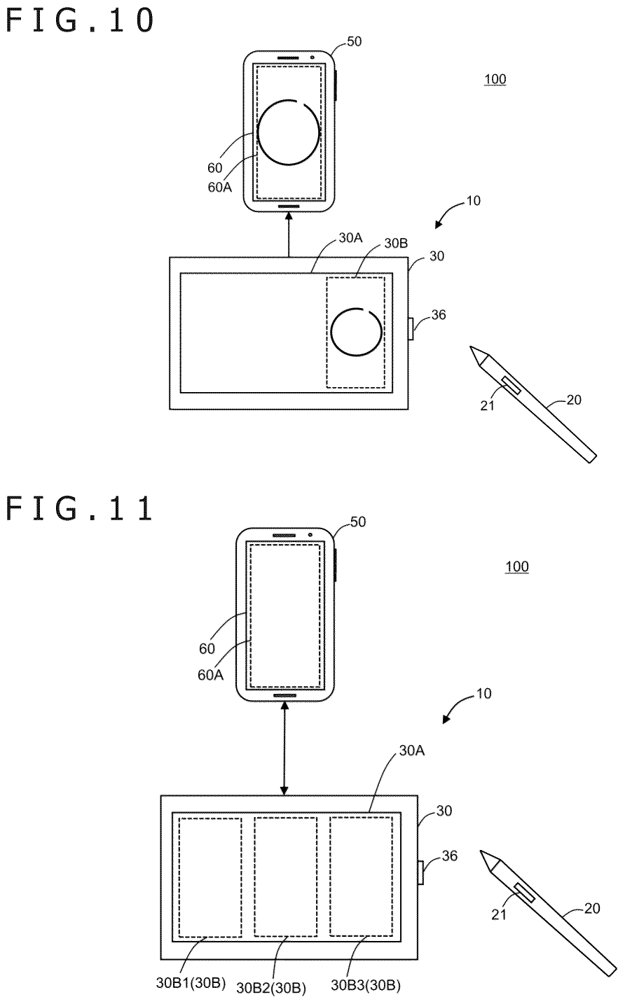

FIG. 10 depicts an example of drawing action after the position detection area 30B is set according to the second setting information transmitted from the electronic device 50 to the position detection device 30. As illustrated in FIG. 10, the position detection area 30B is set as the partial area on the configurable area 30A at a right position of the configurable area 30A to bring the aspect ratio of the position detection area 30B into line with the aspect ratio of the display area 60A set on the display screen 60 of the electronic device 50. In this case, when the user holds the position indicator 20 in hand and indicates a desired position of the position detection area 30B so as to draw a circle, the circle is drawn in the display area 60A set on the display screen 60 of the electronic device 50 without being stretched in the vertical direction or the horizontal direction.

As described above in detail, the input system 100 includes the position detection device 30 and the electronic device 50 in the present embodiment. The position detection device 30 and the electronic device 50 can be connected for communication. The position detection device 30 detects the position indicated by the position indicator 20 in the position detection area 30B set on the position detection device 30. The electronic device 50 executes the process according to the position of the display area 60A that corresponds to the indicated position detected in the position detection area 30B and that is set on the display screen 60 of the electronic device 50. The electronic device 50 includes the setting information generator 51b and the transmission control 51c. The setting information generator 51b generates the second setting information for configuring the settings in relation to the aspect ratio of the position detection area 30B, according to the first setting information set in relation to the aspect ratio of the display area 60A, when the position detection device 30 and the electronic device 50 are connected for communication. The transmission control 51c transmits the generated second setting information to the position detection device 30. The position detection device 30 includes the setting control 31a. The setting control 31a configures the settings related to the aspect ratio of the position detection area 30B according to the second setting information transmitted from the transmission control 51c.

According to the present embodiment configured in this way, the second setting information, for configuring the settings in relation to the aspect ratio of the position detection area 30B, is transmitted to and set in the position detection device 30, according to the first setting information set in relation to the aspect ratio of the display area 60A, when the position detection device 30 and the electronic device 50 are connected for communication. Therefore, the difference between the aspect ratio of the position detection area 30B and the aspect ratio of the display area 60A can be reduced without the time and effort of the user.

Note that in the embodiment, the setting control 31a of the position detection device 30 may change the set position of the position detection area 30B on the position detection device 30 according to the user operation on the operation unit after configuring the settings related to the aspect ratio of the position detection area 30B according to the second setting information transmitted from the transmission control 51c of the electronic device 50. FIG. 11 is an explanatory diagram describing an action of changing the set position of the position detection area 30B. As illustrated in FIG. 11, the setting control 31a sets, for example, the set position of the position detection area 30B on the position detection device 30 at a left position indicated by reference sign 30B1, a center position indicated by reference sign 30B2, or a right position indicated by reference sign 30B3 according to the user operation on the operation unit, after configuring the settings related to the aspect ratio of the position detection area 30B according to the second setting information transmitted from the transmission control 51c of the electronic device 50. The user operation on the operation unit may include the operation button 21 provided on the position indicator 20 and the operation button 36 provided on the position detection device 30. In this way, the set position of the position detection area 30B can easily be changed by the user operation after the configuration of the settings related to the aspect ratio of the position detection area 30B, thus making use of the position detection device 30 more convenient.

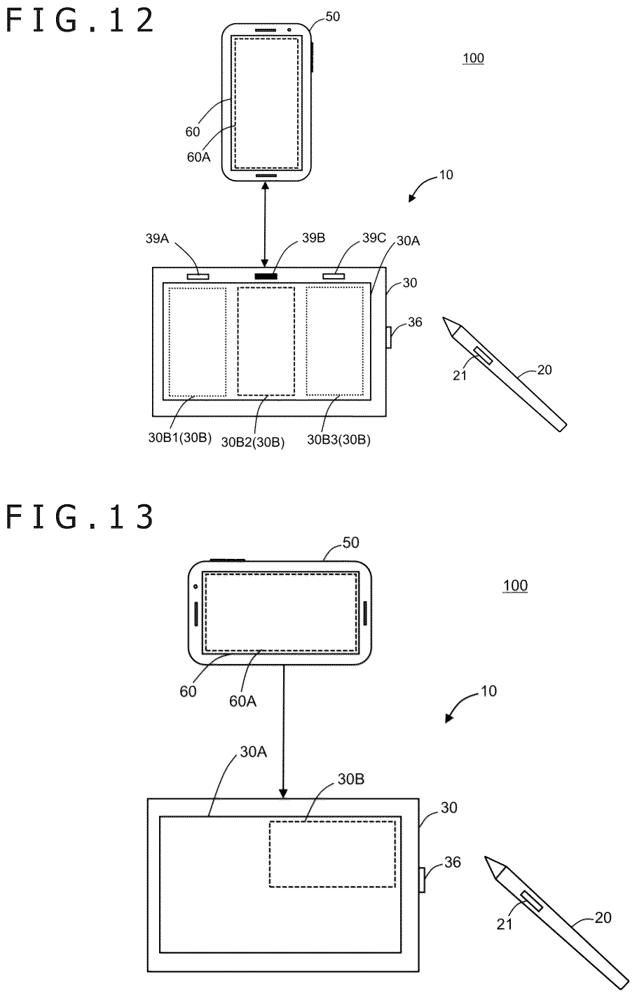

Also, in the embodiment, the position detection device 30 may further include a notification unit that sends a notification when the position detection device 30 and the electronic device 50 are connected for communication. In this case, the notification unit may notify the user of the set position of the position detection area 30B in a notification mode according to the set position of the position detection area 30B. FIG. 12 is an explanatory diagram describing an action of notifying the user of the set position of the position detection area 30B. The position detection device 30 includes light emitting diodes (LEDs) 39A, 39B, and 39C as notification units that send a notification when the position detection device 30 and the electronic device 50 are connected for communication. The controller 31 controls the LEDs 39A, 39B, and 39C to light up when the position detection device 30 and the electronic device 50 are connected for communication, thereby notifying the user that the position detection device 30 and the electronic device 50 are connected for communication.

The LEDs 39A, 39B, and 39C notify the user of the set position of the position detection area 30B in a notification mode according to the set position of the position detection area 30B. For example, when the set position of the position detection area 30B is at the left position indicated by reference sign 30B1, the controller 31 controls the LED 39A to light up to notify the user that the set position of the position detection area 30B is at the left position. When the set position of the position detection area 30B is at the center position indicated by reference sign 30B2, the controller 31 controls the LED 39B to light up to notify the user that the set position of the position detection area 30B is at the center position as illustrated in FIG. 12. When the set position of the position detection area 30B is at the right position indicated by reference sign 30B3, the controller 31 controls the LED 39C to light up to notify the user that the set position of the position detection area 30B is at the right position. In this way, the user can check the lighting state of the LEDs 39A, 39B, and 39C to easily figure out the current set position of the position detection area 30B.

Note that other examples of modes of notifying the user of the set position of the position detection area 30B include a mode in which the speaker 55 of the electronic device 50 reproduces an acoustic signal to aurally send a notification, a mode of displaying an image on the display 54 of the electronic device 50 to visually send a notification, a mode of generating light by controlling the color of light, the pattern of lighting/flashing, the intensity of light, or the like in the electronic device 50 to visually send a notification, and a mode of controlling the pattern, the strength, or the like of vibration and generating vibration by using the vibration function of the electronic device 50 to tactilely send a notification. Note that the acoustic signal includes a human voice message, a buzzer sound, a chime sound, an alarm sound, or the like. The image displayed on the display 54 is an image including at least one of elements including a figure, computer graphics, a photograph, a character, a number, or a symbol, and the image may include a combination of two or more elements. The image may be either one of a monochrome image or a color image, and the image may be either one of a still image or a moving image.

Also, in the embodiment, when the display mode of the display screen 60 of the electronic device 50 is changed from one of a vertical display mode or a horizontal display mode to the other through the operation of the user on the display 54 of the electronic device 50, the setting information generator 51b of the electronic device 50 may generate the second setting information according to the display mode after the change.

FIG. 13 is an explanatory diagram describing an action when the display mode of the display screen 60 of the electronic device 50 is changed. As illustrated in FIG. 13, when the display mode of the display screen 60 is changed from one (vertical display mode) of the vertical display mode or the horizontal display mode to the other (horizontal display mode), the setting information generator 51b of the electronic device 50 refers to the first setting information and the mapping information stored in the storage 52 to generate the second setting information for configuring the settings in relation to the aspect ratio of the position detection area 30B to bring the aspect ratio of the display area 60A into line with the aspect ratio of the position detection area 30B. The transmission control 51c transmits the second setting information generated by the setting information generator 51b to the position detection device 30 through the communication circuit 53. The setting control 31a of the position detection device 30 changes the settings related to the aspect ratio of the position detection area 30B on the configurable area 30A of the position detection device 30 according to the second setting information and the mapping information transmitted from the transmission control 51c of the electronic device 50, in comparison with before the change in the display mode of the display screen 60.

In this way, even when the display mode of the display screen 60 is changed, the settings related to the aspect ratio of the position detection area 30B can be changed to bring the aspect ratio of the display area 60A into line with the aspect ratio of the position detection area 30B without the time and effort of the user.

Also, in the embodiment, when the arrangement direction of the position detection device 30 from the user is changed from one of the vertical direction and the horizontal direction to the other, the setting information generator 51b of the electronic device 50 may generate the second setting information for setting the position detection area 30B of the position detection device 30 in a size larger than the display area 60A of the electronic device 50.

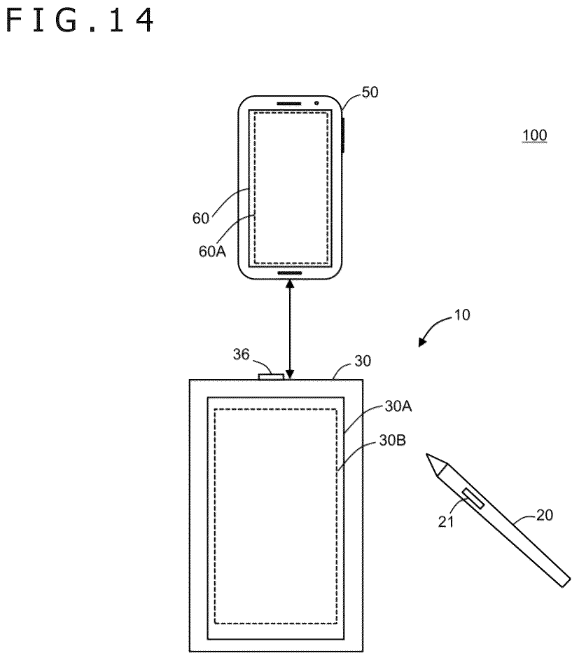

FIG. 14 is an explanatory diagram describing an action when the arrangement direction of the position detection device 30 is changed. As illustrated in FIG. 14, when the arrangement direction of the position detection device 30 is changed from one (horizontal direction) of the vertical direction or the horizontal direction to the other (vertical direction), the setting information generator 51b of the electronic device 50 refers to the first setting information and the mapping information stored in the storage 52 to generate the second setting information for configuring the settings in relation to the aspect ratio of the position detection area 30B to bring the aspect ratio of the display area 60A into line with the aspect ratio of the position detection area 30B and make the size of the position detection area 30B larger than the size of the display area 60A. The transmission control 51c transmits the second setting information generated by the setting information generator 51b to the position detection device 30 through the communication circuit 53. The setting control 31a of the position detection device 30 changes the settings related to the aspect ratio of the position detection area 30B on the configurable area 30A of the position detection device 30, according to the second setting information and the mapping information transmitted from the transmission control 51c of the electronic device 50, in comparison with before the change in the arrangement direction of the position detection device 30.

In this way, even when the arrangement direction of the position detection device 30 is changed, the settings related to the aspect ratio of the position detection area 30B can be changed to bring the aspect ratio of the display area 60A into line with the aspect ratio of the position detection area 30B and make the size of the position detection area 30B larger than the size of the display area 60A without the time and effort of the user. Note that the user may be able to further freely adjust the size of the position detection area 30B according to their preferences. This can further improve convenience when using the position detection device 30.

The embodiment as described is intended to illustrate an example for implementing the present disclosure and should not be construed as limiting the technical scope of the present disclosure. That is, the present disclosure can be implemented in various forms without departing from the scope and main features of the present disclosure.

1. An input system, comprising:
a position detection device; and
an electronic device, wherein
the position detection device and the electronic device are connectable to each other for communication,
the position detection device detects a position indicated by an indicator in a position detection area set on the position detection device,
the electronic device executes a process according to a position of a display area that corresponds to the indicated position detected in the position detection area and that is set on a display screen of the electronic device,
the electronic device includes a setting information generator and a transmission control,
the setting information generator generates second setting information for configuring settings in relation to an aspect ratio of the position detection area, according to first setting information set in relation to an aspect ratio of the display area when the position detection device and the electronic device are connected for communication,
the transmission control transmits the generated second setting information to the position detection device,
the position detection device includes a setting control, and
the setting control configures the settings related to the aspect ratio of the position detection area according to the second setting information transmitted from the transmission control.

2. The input system according to claim 1, wherein
the setting control changes a set position of the position detection area on the position detection device according to a user operation on an operation unit after configuring the settings related to the aspect ratio of the position detection area according to the second setting information.

3. The input system according to claim 1, wherein
the position detection device further includes a notification unit, and
the notification unit sends a notification when the position detection device and the electronic device are connected for communication.

4. The input system according to claim 3, wherein
the notification unit sends a notification of a set position of the position detection area in a notification mode according to the set position of the position detection area.

5. The input system according to claim 1, wherein,
when a display mode of the display screen is changed from one of a vertical display mode and a horizontal display mode to the other, the setting information generator generates the second setting information according to the display mode after the change.

6. The input system according to claim 1, wherein,
when an arrangement direction of the position detection device is changed from one of a vertical direction and a horizontal direction to the other, the setting information generator generates the second setting information for setting the position detection area in a size larger than the display area.

7. An electronic device comprising:
a process execution unit;
a setting information generator; and
a transmission control, wherein
the electronic device is connectable for communication to the position detection device,
the position detection device detects a position indicated by an indicator in a position detection area set on the position detection device,
the process execution unit executes a process according to a position of a display area that corresponds to the indicated position detected in the position detection area and that is set on a display screen of the electronic device,
the setting information generator generates second setting information for configuring settings in relation to an aspect ratio of the position detection area, according to first setting information set in relation to an aspect ratio of the display area, when the position detection device and the electronic device are connected for communication, and
the transmission control transmits the generated second setting information to the position detection device.

8. A non-transitory computer-readable medium including instructions and data, which are to be loaded onto an electronic device, wherein
the electronic device is connectable for communication to a position detection device,
the position detection device detects a position indicated by an indicator in a position detection area set on the position detection device,
the electronic device includes a process execution unit, a setting information generator, and a transmission control, and
the instructions and data, when loaded onto the electronic device:
cause the process execution unit to execute a process according to a position of a display area that corresponds to the indicated position detected in the position detection area and that is set on a display screen of the electronic device,
cause the setting information generator to generate second setting information for configuring settings in relation to an aspect ratio of the position detection area, according to first setting information set in relation to an aspect ratio of the display area, and
cause the transmission control to transmit the generated second setting information to the position detection device.
